(19) United States
(12) Patent Application Publication
(10) Pub. No.: US 2026/0356609 A1
(43) Pub. Date: Nov. 12, 2026

(54) HYBRID SEALS FOR LOADING DOCKS

(71) Applicant: Rite-Hite Holding Corporation, Milwaukee, WI (US)

(72) Inventors: Gary D. Borgerding, Dubuque, IA (US); Adam D. Gorkow, Mineral Point, WI (US); Frank J. Heim, Platteville, WI (US); Bruce Henning, Dubuque, IA (US)

(21) Appl. No.: 19/483,865

(22) PCT Filed: May 10, 2024
(86) PCT No.: PCT/US2024/028913

§ 371 Date: Nov. 12, 2025

Related U.S. Application Data
(60) Provisional application No. 63/501,985, filed on May 12, 2023.

(51) Int. Cl. B65G 69/00; F16J 15/02

(52) U.S. Cl. CPC B65G 69/008; F16J 15/02

(57) ABSTRACT

Hybrid seals for loading docks are disclosed. An example apparatus includes a side frame to couple to a loading dock wall, a hook, a stay to couple the hook and the side frame, the stay to enable the hook to move relative to the side frame, and a fabric cover coupled to the side frame. The fabric cover at least partially covers the hook and the stay. At least one of the hook or the stay to slide relative to the fabric cover.

### CROSS-REFERENCE TO RELATED APPLICATIONS

This patent claims the benefit of U.S. Provisional Patent Application No. 63/501,985, which was filed on May 12, 2023. U.S. Provisional Patent Application No. 63/501,985 is hereby incorporated herein by reference in its entirety. Priority to U.S. Provisional Patent Application No. 63/501,985 is hereby claimed.

### FIELD OF THE DISCLOSURE

This disclosure relates generally to loading docks and, more particularly, to hybrid seals for loading docks.

### BACKGROUND

Buildings employ loading docks for loading and/or unloading goods between buildings and vehicles. A loading dock of a building includes an exterior doorway with an elevated loading dock platform positioned adjacent the doorway. To seal an area around a perimeter of the doorway, loading docks often employ shelters or seals that interact with a vehicle to provide a seal between an interior of the building and an exterior of the building.

### BRIEF DESCRIPTION OF THE DRAWINGS

FIG. 1A is a partial perspective front view of an example loading dock having an example hybrid seal in accordance with teachings of this disclosure. The example hybrid seal of FIG. 1A is in an example inactive or relaxed position.

FIG. 1B is a perspective side view of the example loading dock and the example hybrid seal of FIG. 1A.

FIG. 1C is another perspective side view of the example loading dock and the example hybrid seal of FIG. 1A.

FIG. 1D is a perspective view of the example loading dock of FIG. 1A with an example vehicle at the example loading dock.

FIG. 1E is cross-sectional top view of the example vehicle of FIG. 1A.

FIG. 2 is a partial perspective view of the example loading dock of FIG. 1A with the example hybrid seal in an example activated or actuated position.

FIG. 3 is a cross-sectional top view of the example hybrid seal in the inactive position of FIG. 1A.

FIG. 4 is a perspective view of portion of an example side structure of the example hybrid seal of FIGS. 1A, 2 and 3.

FIG. 5 is a partial perspective view of an example hook and an example stay of the example hybrid seal of FIGS. 1A and 2-4.

FIG. 6 is a partial perspective view of the example stay and the example frame of the example hybrid seal of FIGS. 1A and 2-4.

FIG. 7 is a cross-sectional top view of the example hybrid seal of FIG. 2 shown in the activated position of FIG. 2.

FIGS. 8-13 are partial, perspective views of the example hybrid seal of the example loading dock of FIGS. 1A and 2-7 at different positions between the example inactive position and the example activated position.

FIG. 14A is a cross-sectional side view of the example hybrid seal of FIGS. 1A and 2-13 with an example bumper disclosed herein.

FIG. 14B is a front view of the example bumper and the example hybrid seal of FIG. 14A.

FIG. 15 is partial perspective view of the example loading dock of FIGS. 1A, 2-7, and 14A-14B from a viewpoint of inside a vehicle parked at the loading dock looking toward a direction inside a building of the loading dock.

FIGS. 16A-16B are partial views of the example hybrid seal 102 of FIGS. 1A, 2-13, and 14A-14B including an example tether 1600.

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Buildings include loading docks to facilitate loading/unloading of goods relative to vehicles situated at the loading docks. An example building typically includes a doorway (e.g., an opening) disposed in a building wall that is elevated relative to a driveway leading to the loading dock. To facilitate a loading/unloading operation, the vehicle is backed into the driveway and positioned to align an entrance of a cargo bay of the vehicle with the doorway of the loading dock. When the vehicle is parked at the loading dock, a gap can form between a rear end of the vehicle (e.g., a tailer) and a perimeter of the doorway. Further, a vehicle having swing-out trailer doors includes hinges that form gaps (e.g., hinge gaps) between respective rear side panels of the tailer and the trailer doors.

A gap between the vehicle and building wall and/or the hinge gaps provide an opening(s) through which air (e.g., heated air, air conditioning, etc.) and/or undesirable contaminants (e.g., dust, wind, rain, bugs and rodents, etc.) can enter and/or exit the building. To seal or reduce these gaps, loading docks typically employ a shelter or a seal. Shelters and/or seals include sealing/sheltering structures that couple to a dock face adjacent the doorway and extend a distance over the doorway. As used herein, the dock face is an exterior portion of a building wall having the loading dock. In general, loading dock seals and shelters restrict or prevent the ingress of environmental conditions or contaminants (e.g., rain, snow, wind, hot/cold temperatures, insects, animals, etc.) into the interior of a building (e.g., the dock area) and cargo area of a vehicle during the loading or unloading of the vehicle and/or the egress of conditioned (e.g., heated or cooled) air between a building and/or a vehicle cargo area and the outdoor environment.

Seals typically include impactable structures (e.g., foam pads) mounted to the dock face adjacent a perimeter of the doorway. For example, the seals may include side foam pads mounted to the dock face adjacent lateral edges (e.g., vertical sides) of the doorway and/or a header foam pad mounted to the dock face adjacent an upper edge (e.g., a horizontal edge) of the doorway. The foam pads typically extend a distance over the doorway and are structured to be impacted and compressed by a rear end of a vehicle approaching the doorway. In particular, as the vehicle comes to a rest at the doorway, the rear end of the trailer compresses into the foam pads to enclose or seal a gap between the doorway and the vehicle (e.g., a gap along a perimeter of the doorway and/or around three sides of the trailer). In other words, the seal is structured to form a gasket-type seal between the rear end of the trailer and the foam pads. Additionally, seals typically have a smaller footprint compared to shelters and, thus, take up less space on the building wall and/or outside of the loading dock.

However, seals can expand into a travel path of a vehicle used during loading/unloading operation and, thus, can be susceptible to interfering with loading/unloading operations. For example, when the seals are compressed by a vehicle, a portion of the side foam pads can protrude into an opening at the rear end of the trailer, which can cause forklifts entering and/or exiting the trailer to engage and/or damage the seals. In some examples, the seals limit a range of vehicle sizes (e.g., trailer widths) that can utilize the loading dock (e.g., due to fixed horizontal distance between the seals when mounted to the building wall). In some instances, the foam pads of the seals tends to bridge over the hinges on the trailer and, thus, may not provide a sufficient or effective seal around hinge gaps formed by the trailer doors, and thereby reducing a seal efficiency of the seals. Moreover, the foam pads of the seals can be prone to high instances of wear at loading docks that receive heavy traffic.

Shelters include side curtains (e.g., flexible sealing material) coupled to, and extending from, side frames mounted to the dock face adjacent lateral edges of the doorway. In some examples, a hook member extends from the side curtains to engage a rear edge of a vehicle (e.g., along an entire length of the hinge gap) to seal against side panels of the vehicle. The side frames are positioned substantially parallel relative to the lateral edges of the doorway and typically extend along the lateral edges of the doorway. The side frames protrude a distance outward from the dock face. In other words, the side frames retain the side curtains above the ground and offset from the doorway. The side curtains retain an elastic frame (e.g., a flexible skeleton, etc.) that provides support and rigidity to the side curtains.

As a vehicle approaches the shelter, the rear end of the trailer first impacts the side curtain. As the vehicle continues to back towards the doorway and come to a rest, lateral edges of the vehicle's rear end slide along the side curtain and engage the hooks of the side curtains at respective rear, lateral edges (e.g., vertical edges) of the vehicle. In turn, the hooks wrap around the respective rear lateral edges of the trailer. The hooks bridge the hinge gaps opened by the trailer doors and the side curtains engage with rear side panels of the trailer to provide a wiper seal against the rear side panels of the trailer, thereby effectively sealing a perimeter of the doorway and/or three edges of the vehicle.

The side frames of the shelters are structured to support their own weight, a weight of the side curtains, and any forces applied thereto. The side frames can be mechanically coupled to the dock face to provide increased lateral rigidity to the shelter to reduce (e.g., minimize) an ability of the side frames to move side-to-side. The side frames are spaced apart from each other to accommodate a range of vehicle sizes and/or off center vehicle positions. For instance, the side frames typically can be mounted relatively far apart to accommodate a wide range of possible off-center vehicle positions. This relatively large distance between the rigid side members consumes a significant and, thus, expensive amount of building wall space for each loading dock opening. Based on at least the foregoing, the shelters are larger than seals, consuming a relatively large amount of space on the dock face. Further, the side frames of the shelters are not typically impactable due to the forces they undergo. Thus, the shelters may be damaged if impacted by a vehicle at the side frames when a vehicle approaches the loading dock in a position that is too far off-center relative to the center of the doorway. Moreover, the shelters are typically considerably more expensive than the seals. Accordingly, cost and size is often weighted against sealing efficiency when selecting between shelters and seals.

Example methods, apparatus, and articles of manufacture disclosed herein employ hybrid seals that seal a bay of a loading dock to provide thermal protection and/or control of an environment at the loading dock. In particular, example hybrid seals disclosed herein seal a gap between a rear end of a vehicle positioned at the loading dock and a perimeter of a loading dock doorway and/or hinge gaps between the rear end of the vehicle and door panels coupled thereto (e.g., via hinges) that form when the doors are in respective open positions.

Example hybrid seals disclosed herein include (e.g., first and second) side structures or assemblies structured to be mounted to a loading dock face on respective lateral sides of the doorway of the loading dock. Example side structures disclosed herein include impactable side frames structured to mount to the dock face on lateral sides of the doorway. An example impactable side frame disclosed herein includes an example foam core coupled between an example backer panel (e.g., for mounting to the dock face) and an example front panel to provide support and/or an attachment surface. In some examples, an impactable side frame can be reinforced with a flexible, semi-rigid material including, but not limited to, a high molecular weight polyethylene (HMWPE), rubber or other plastics with similar properties, etc.

Example impactable side frames disclosed herein can include a frame height that corresponds to a height of the doorway (e.g., from a concrete foundation to a header of the doorway). In some examples, example impactable side frame disclosed herein can include a frame height that is less or greater than a height of the doorway. Example impactable side frames disclosed herein can extend from a (e.g., concrete) foundation towards an example header structure of the hybrid seal. The header structure is structured to close a gap formed along a top surface or upper edge of the trailer. In other examples, example impactable side frames disclosed herein can include a height that corresponds to the largest vehicle(s) that service the loading dock.

Example side structures disclosed herein include an example sealing hook coupled to the impactable side frame via one or more example elastic stays (e.g., via example attachment structure(s) or surface(s)). For example, example elastic stays disclosed herein can be coupled between the impactable side frames and the sealing hooks. Further, example side structures disclosed herein include an example fabric cover (e.g., sealing material, a vinyl fabric, a wrap, etc.) that encloses or encases (e.g., fully encases) the impactable side frame, the elastic stays, and the sealing hook. For example, the fabric cover can be coupled to the backer panel and/or the dock face at a first lateral side of the impactable side frame and/or a first lateral edge of the sealing material, wrapped to extend around the impactable side frame, the elastic stays, and the sealing hook, and coupled to the backer panel and/or the dock face at a second lateral side of the impactable side frame and/or a second lateral edge of the fabric cover.

Example hybrid seals disclosed herein require less space on a dock face compared to traditional shelters. Additionally, unlike some traditional shelters, example side frames of the example hybrid seals can be impacted by a vehicle. A relatively shorter distance between the impactable side frames consumes a smaller footprint compared to traditional shelters and, thus, reduces an amount of building wall space needed for each loading dock opening. Example hybrid seals disclosed herein provide an efficient seal at a relatively lower cost compared to shelters.

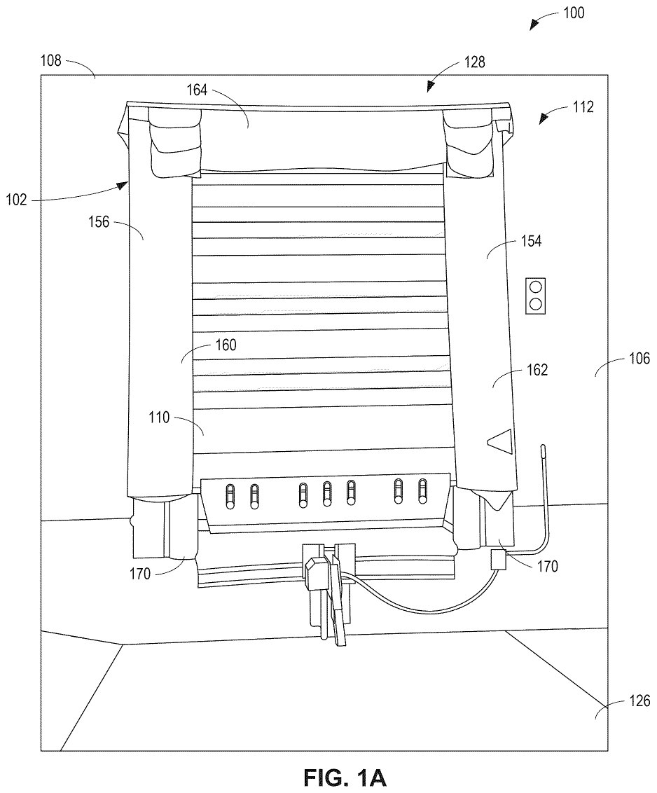

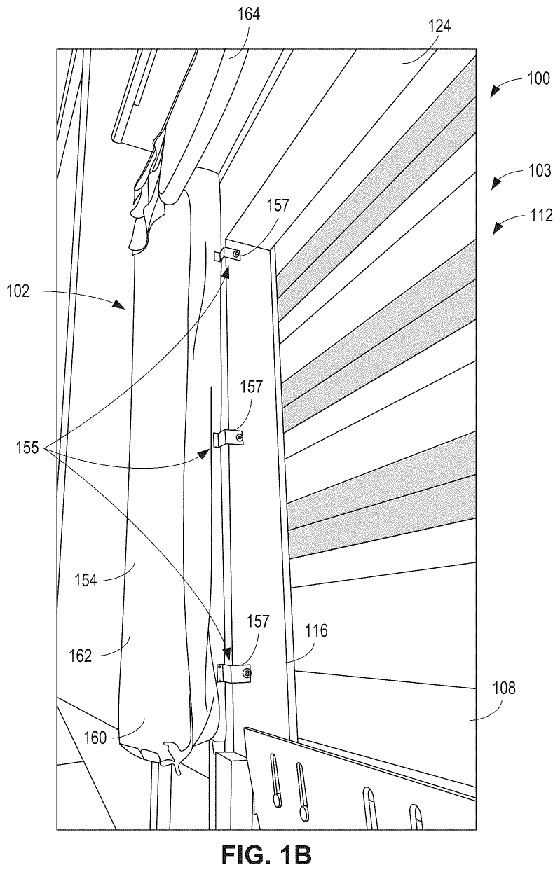

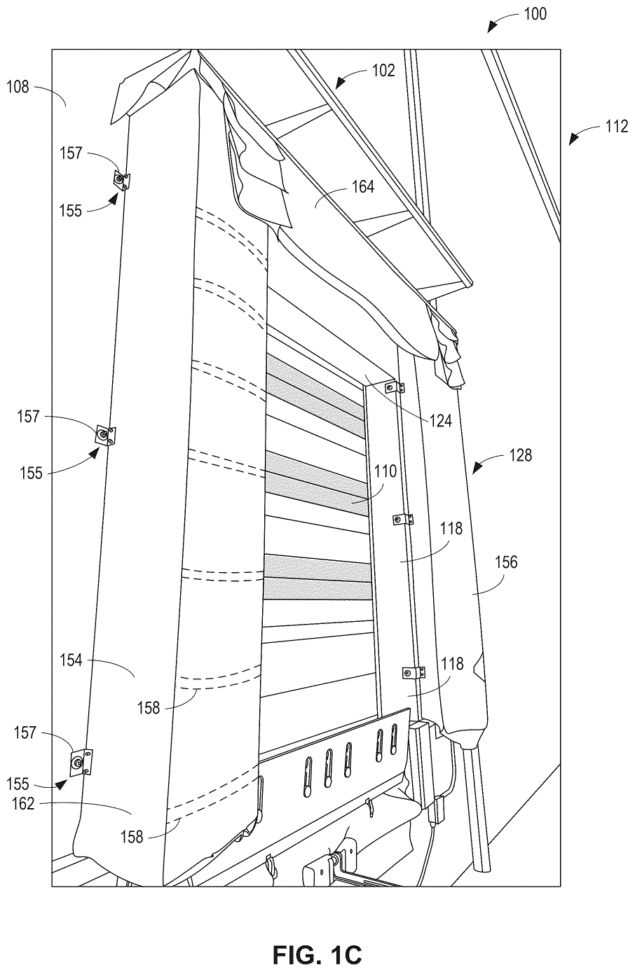

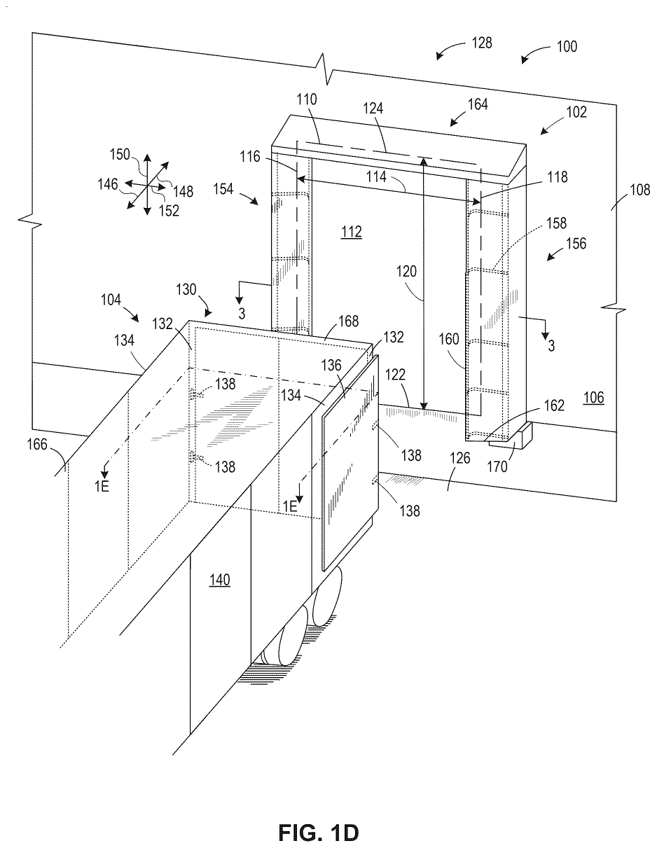

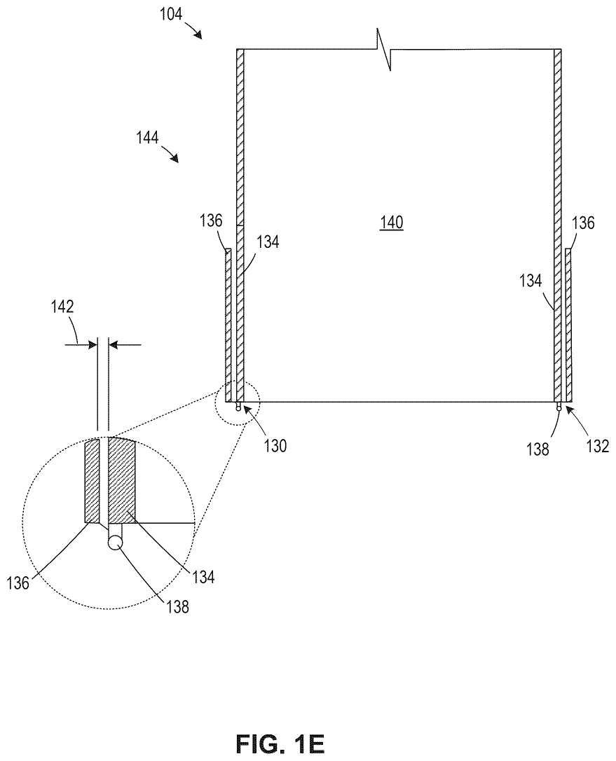

FIG. 1A is a perspective view of an example loading dock 100 having an example hybrid seal 102 constructed in accordance with teachings disclosed herein. FIG. 1B is a perspective side view of the example loading dock 100 and the example hybrid seal 102 of FIG. 1A. FIG. 1C is another perspective side view of the example loading dock 100 and the example hybrid seal 102 of FIG. 1A. FIG. 1D is a perspective view of the example loading dock of FIG. 1A with an example vehicle 104 at the example loading dock 100. FIG. 1E is a cross sectional top view of a vehicle 104 of FIG. 1A along the line 1E-1E of FIG. 1D.

Referring to FIG. 1A-1D, the loading dock 100 includes a dock face 106 (e.g., a building wall, a concrete foundation, a base, etc.) of a building 108. The dock face 106 of the illustrated example includes or otherwise defines a doorway 110 that provides an entrance to a bay 112 of the loading dock 100 (e.g., an interior of the building 108). The doorway 110 defines perimeter edges of an opening in the dock face 106. The doorway 110 has a width 114 (FIG. 1D) between a first lateral side 116 (e.g., a first lateral edge) of the doorway 110 and a second lateral side 118 (e.g., a second lateral edge) of the doorway 110. The doorway 110 has a height 120 (FIG. 1D) between a loading dock floor 122 (e.g., a top surface of the foundation 106 or a lower edge of the doorway 110) and a header 124 of the doorway 110 (e.g., an upper edge of the doorway 110). While a single loading bay 112 is illustrated in FIGS. 1A-1D, the loading dock 100 can include a plurality of loading bays positioned adjacent the loading dock bay 112. The loading dock 100 includes an example driveway 126 that provides a pathway leading to the doorway 110 to permit the vehicle 104 access to the loading dock bay 112. The vehicle 104 of the illustrated example is disengaged from the hybrid seal 102. When the vehicle 104 is not in engagement with the hybrid seal 102, the hybrid seal 102 is in an example inactive or relaxed position 128 (e.g., non-engaged position).

Referring to FIGS. 1D and 1E, the vehicle 104 includes an example rear end 130 defining rear lateral or vertical edges 132, example rear side panels 134, and example door panels 136 (e.g., swinging-type doors). The rear end 130 orients or faces towards the dock face 106 when the vehicle 104 backs towards to the doorway 110. The door panels 136 of the vehicle 104 of FIGS. 1D and 1E are pivotally coupled to respective rear lateral edges 132 and/or respective rear side panels 134 of the vehicle 104 via example hinges 138. Prior to backing the vehicle 104 into the hybrid seal 102, the door panels 136 are opened to facilitate access to the cargo bay 140 from the loading dock bay 112. Referring to FIG. 1E, a hinge gap 142 forms between the door panels 136 and the respective rear side panels 134 of the vehicle 104 when the door panels 136 are in an open position 144 (e.g., a fully opened position). The hinge gaps 142 typically extend along a full length of the door panels 136. To load and/or unload the cargo bay 140 of the vehicle 104, the vehicle 104 is backed into the loading dock 100 with the door panels 136 in the open position 144 and the rear end 130 of the vehicle 104 aligns with the doorway 110 of the loading dock 100, which provides a passageway between the loading dock bay 112 and the cargo bay 140 of the vehicle 104.

Referring to FIGS. 1A-1D, as the vehicle 104 moves rearward 148 towards the doorway 110, the rear end 130 of the vehicle 104 engages the hybrid seal 102. To facilitate discussion of the hybrid seal 102, the loading dock 100 of the illustrated example is described herein with directional references including an example forward direction 146 (e.g., an outward or horizontal direction away from the dock face 106), an example rearward direction 148 (e.g., an inward or horizontal direction toward to the dock face 106), an example vertical direction 150 (e.g., a direction substantially perpendicular relative to the loading dock floor 122), and an example lateral direction 152 (e.g., a direction substantially perpendicular to the rearward direction and the vertical direction). The term lateral direction is used herein to describe a position of a component relative to a doorway (e.g., the doorway 110 of the loading dock 100 and/or a doorway defined by the rear end 130 of the vehicle 104). For example, a laterally positioned component relative to the building 108 is a component that is substantially parallel relative to the height 120 of the doorway 110 and offset in a direction substantially parallel to the width 114 of the doorway 110.

The hybrid seal 102 of the illustrated example includes example side structures 154, 156 (e.g., lateral side structures, side assemblies, etc.) mounted to the dock face 106. In particular, the hybrid seal 102 of the illustrated example includes an example first side structure or assembly 154 mounted to the dock face 106 adjacent the first lateral edge 116 of the doorway 110 and an example second side structure or assembly 156 mounted to the dock face 106 adjacent the second lateral edge 118 of the doorway 110. Each of the side structure assemblies 154, 156 are mounted to the dock wall 108, the doorway 108 and/or the loading dock 100 via fasteners 155. The fasteners 155 of the illustrated example are brackets 157 (e.g., L-brackets) that couple to the dock wall 108 and the side structures 154, 156 via screws, bolts, anchors, and/or other fastener(s).

The first and second side structures 154, 156 of the illustrated example are structured to be impacted by the rear end 130 of the vehicle 104 when the vehicle 104 parks at the loading dock 100 against the hybrid seal 102 during a loading/unloading operation. Each of the side structures 154, 156 include one or more stays 158 (e.g., elastic stays), a hook 160 (e.g., a sealing hook), and a fabric cover 162. The stays 158 of the illustrated example are horizontally elongate and are spaced (e.g., vertically) along a height (e.g., a vertical height) of the respective side structures 154, 156.

The hybrid seal 102 of the illustrated example includes an example header structure 164, which seals a gap between the header 124 of the doorway 110 and a roof 166 of the vehicle 104. Portions of the header 124 are omitted in FIG. 1D for clarity. For example, the header structure 164 seals a gap between an upper edge 168 (e.g., a top edge) of the rear end 130 of the vehicle 104 and the header 124 of the doorway 110. In the illustrated example, the header structure 164 extends between the side structures 154, 156 along an upper portion of the doorway 110. The header structure 164 of the illustrated example is configured to seal (i.e., to provide an environmental barrier) along the top portion of the vehicle 104 when the vehicle 104 is backed into hybrid seal 102. The header structure 164 can be implemented using any conventional or known header structures or head curtains. Alternatively, the header structure 164 can be implemented using flexible or impactable structures similar to those used to implement the side structures 154 and 156, examples of which are described in greater detail below. In some examples, the hybrid seal 102 can include a horizontal seal instead of the header structure 164.

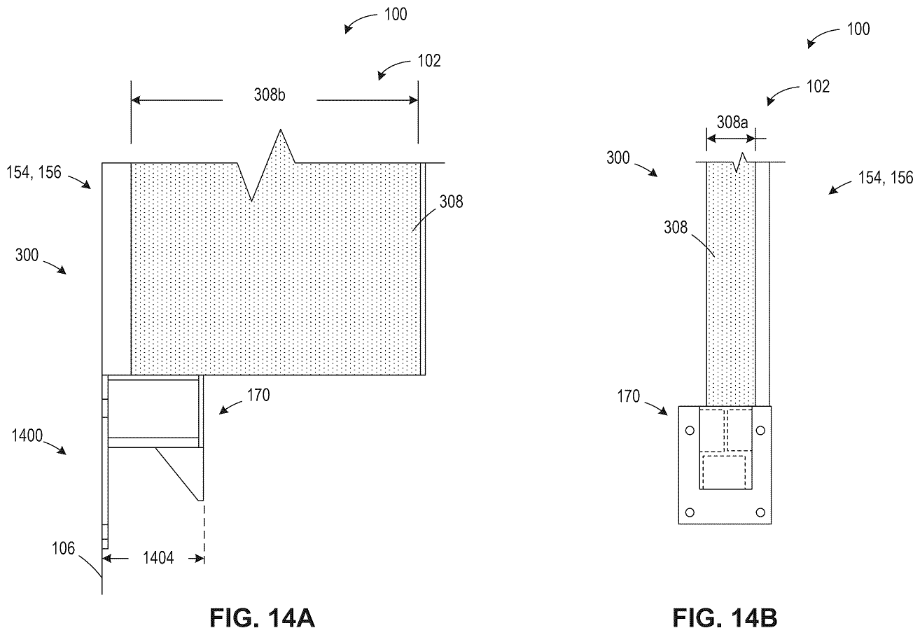

In the illustrated example, the loading dock 100 includes example bumpers 170 (e.g., dock fenders) coupled to the foundation 106 to protect or otherwise prevent damage to the loading dock 100 (e.g., the dock face 106). An example implementation of the bumpers 170 is discussed in further detail in relation to FIGS. 14A-14B. The bumpers 170 of the illustrated example are positioned beneath the respective side structures 154, 156 and do not interfere with the operation of the hybrid seal 102.

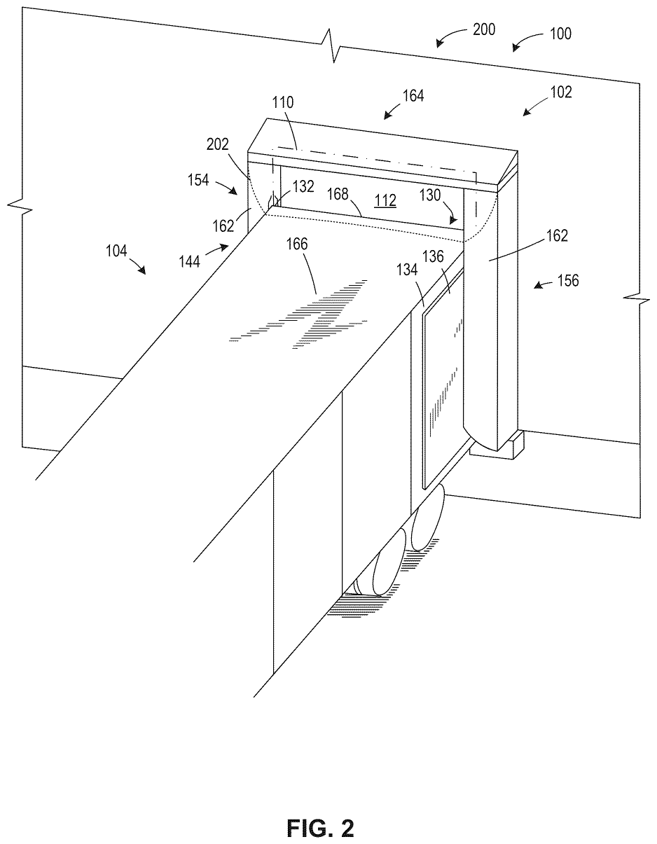

FIG. 2 is a perspective view of the loading dock 100 of FIGS. 1A-1D with the hybrid seal 102 in an example activated or actuated position 200. To move the hybrid seal 102 from the inactive position 128 of FIGS. 1A-1D to the activated position 200 of FIG. 2, the vehicle 104 backs into and/or engages the hybrid seal 102 as the vehicle 104 moves toward the doorway 110. For example, the vehicle 104 is shown in FIG. 2 in an example parked position relative to the loading dock 100. In the parked position, the vehicle 104 (e.g., the rear end 130 of the vehicle 104) engages (e.g., direct contact) with the hybrid seal 102. As illustrated in FIG. 2, when the vehicle 104 is parked at the loading dock 100 for loading and/or unloading operations, the hybrid seal 102 seals the loading dock bay 112. Specifically, the hybrid seal 102 of the illustrated example provides a seal about a perimeter of the doorway 110 and/or seals the hinge gaps 142 (FIG. 1E) formed by the door panels 136 at the rear end 130 of the vehicle 104 when the door panels 136 are in the open position 144. In particular, the fabric cover 162 of the first side structure 154 and the fabric cover 162 of the second side structure 156 wrap around the rear lateral edges 132 of the vehicle 104 and engage or sweep against portions of the rear side panels 134 and the door panels 136.

The hybrid seal 102 of FIG. 2 includes the header structure 164. In some examples, the hybrid seal 102 of the illustrated example can include an example header curtain 202 (illustrated using phantom lines) that engages or sweeps against a portion of the roof 166. For example, as the vehicle 104 backs into the loading dock 100, the header curtain 202 engages or drags up and over the top edge 168 of the vehicle 104 to seal against the roof 166. When the vehicle 104 releases or pulls away from the impacted side structures 154, 156, the side structures 154, 156 return to their original condition without any substantial permanent deformation to the side structures 154, 156 or the shapes and/or geometries formed thereby. In some examples, the loading dock 100 of the illustrated example includes a vehicle alignment system or structure (e.g., wheel-guide structures, rails, tracks, or other structures) to direct, guide or facilitate vehicle alignment relative to the doorway 122 of the loading dock 100 in a lateral or horizontal direction. For example, vehicle alignment system or structures center a center of the trailer 134 relative to a center of the doorway 122 (e.g., a midpoint of the width 144). The vehicle alignment systems or structures (e.g., wheel guards) contain trailer offset relative to a centerline of the doorway 122 in the lateral or horizontal direction 152. In some examples, vehicle alignment structures can include cones, markings painted on the driveway, stanchions positioned in the driveway, rails, and/or any other suitable wheel guide(s).

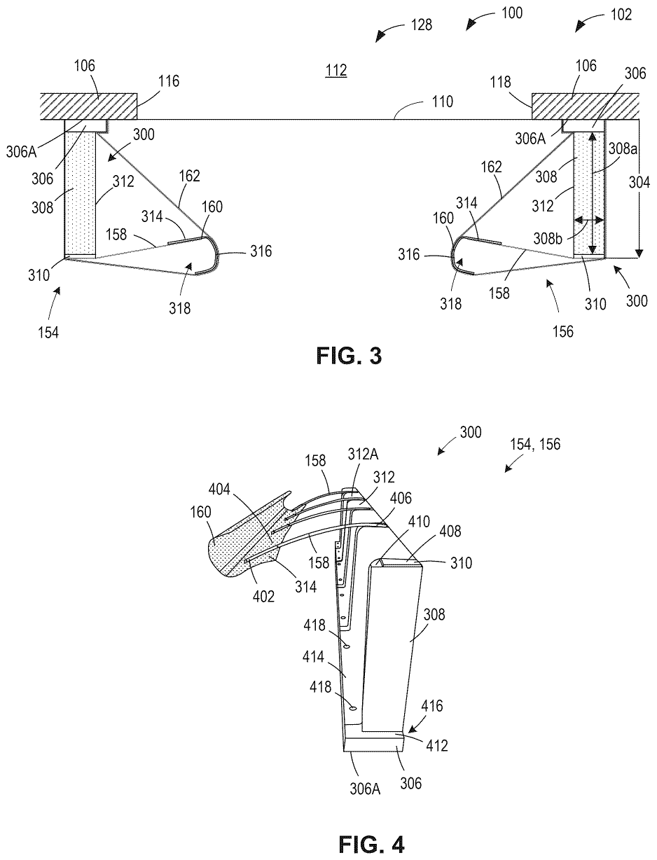

FIG. 3 is a cross-sectional top view of the loading dock 100 and the example hybrid seal 102 of FIGS. 1A-1D taken along the line 3 -3 of FIG. 1D. The hybrid seal 102 of the illustrated example is in the inactive position 128 of FIGS. 1A-1D (e.g., a non-engagement position). The example side structures 154, 156 of the hybrid seal 102 of the illustrated example are mounted to the dock face 106 adjacent respective lateral edges 116, 118 of the doorway 110. Each of the side structures 154, 156 of FIG. 3 includes an example frame 300. Each fabric cover 162 of the illustrated example wraps around at least a portion of the respective frame 300. Thus, each frame 300 is wrapped by the fabric cover 162. In some examples, the fabric cover 162 wraps around the entire respective frame 300. In other words, the fabric cover 162 encases or completely surrounds the respective frame 300.

The fabric cover 162 of the illustrated example is a sealing material (e.g., material shell, wrapping, jacket, casing, etc.) that prevents ingress and/or egress of contaminants relative to the loading dock bay 112 and/or within the side structures 154, 156. For example, the fabric cover 162 can be formed of a vinyl sheet, a vinyl coated fabric, nylon fabric, polyester fabric, non-fabric plastic sheeting, etc. In some examples, the fabric cover 162 can be formed of a material that resists abrasion. The fabric cover 162 can be coupled to the frame 300 using fasteners such as, for example, screws, rivets, etc. In some examples, touch-and-hold fasteners can be used, enabling removal of the fabric cover 162 from the frame 300 to replace the fabric cover 162. During operation, for example, the fabric cover 162 conforms to a position between the example hook 160 and the rear lateral edge 132 of the vehicle 104 (FIGS. 1A-1E, 2). The relative flexibility of the fabric cover 162 enables the fabric cover 162 to conform to the vehicle 104 while being impacted by the vehicle 104 (e.g., as shown in FIG. 2).

The frame 300 of each of the side structures 154, 156 of the illustrated example is positioned (e.g., vertically positioned) on the dock face 106 such that a height of the frame 300 is substantially parallel relative to the lateral edges 116, 118 of the doorway 110. The frame 300 mounts to the dock face 106 and protrudes or extends a distance 304 away from the dock face 106. The frame 300 of the illustrated example includes an example backer 306 (e.g., backer panel), an example core 308, an example front panel 310, and an example cover 312 (e.g., frame cover). The backer 306 of the illustrated example attaches to the dock face 106. The backer 306 of the illustrated example provides a solid surface for mounting the hybrid seal 102 to the dock face 106 and provides support for the core 308. That is, an example first (e.g., rear) side or surface 306A of the backer 306 of the illustrated example is interfaced with (e.g., attached to) the dock face 106. The backer 306 can be formed of wood (e.g., lumber), metal, and/or another material that can couple to the dock face 106 and capable of supporting a weight of a respective one of the side structures 154, 156.

The core 308 of the illustrated example is deformable or compressible (e.g., elastically deformable). For example, the core 308 of the frame 300 can be formed of a resiliently compressible material such as foam (e.g., polyurethane foam), a mechanically resilient structure, etc. In the illustrated example, the core 308 has a width 308a and a length 308b that provide a length-to-width ratio that is greater than 1 (e.g., a length-to-width ratio between approximately 1 and 10). The core 308 of the illustrated example is coupled between the backer 306 and the front panel 310. The front panel 310 of the illustrated example provides an attachment surface for the stays 158. Additionally or alternatively, the front panel 310 of the illustrated example protects the core 308 from wear. The front panel 310 of the illustrated example can be wood, plastic, sheet metal, and/or any other material(s).

The stays 158 of the illustrated example are strips of an elastic material that couple the hook 160 to the frame 300 and/or the core 308. For example, the stays 158 of the illustrated example can be fiberglass, spring steel, and/or another material having a high-yield strength (e.g., a material that resists plastic deformation). In other words, the stays 158 of the illustrated example can be formed of a material that can be bent or deflected by a vehicle 104 and can return to a resting or initial position when the vehicle 104 disengages the hybrid seal 102 as the vehicle 104 departs from the loading dock 100 (e.g., without damage or change in flexibility). In the illustrated example, the stays 158 are strips of material. As used herein, strips of materials means that a length along a longitudinal axis of the stay is greater than the width of the stay. Thus, a length-to-width ratio of the stays 158 is greater than 1 (e.g., 1, 2, 5, 10, etc.). Each of the side structures 154, 156 of the illustrated example includes a plurality of stays 158. However, in some examples, the side structures 154, 156 can each include a single stay. In some examples, each of the side structure 154, 156 can include a single stay that extends substantially along a height of the frame 300.

The frame 300 of each of the side structures 154, 156 includes the hook 160. Thus, the hook 160 of the side structure 154 engages a first one of the rear lateral edges 132 of the vehicle 104 and the hook 160 of the side structure 156 opposite the side structure 154 engages a second one of the rear lateral edges 132 of the vehicle 104. The hook 160 of the illustrated example seals (e.g., is a sealing member structured to cup or curl around) the rear lateral edge 132 of the vehicle 104 to cover the hinge gap 142 between the rear side panel 134 and the door panel 136 of the vehicle 104. For example, the hook 160 of the illustrated example has a J-shaped cross-section. In other examples, the hook 160 can have a c-shaped cross-section, an L-shaped cross-section, etc. The hook 160 of the illustrated example is formed of resiliently flexible but not malleable material. Example materials to form the hook 160 include, but are not limited to, a high molecular weight polyethylene (HMWPE) material, other plastics, rubber, foam, spring steel, etc. and/or combinations thereof. In some examples, the hook 160 can be formed from a sheet of material of HMWPE. For example, the hook 160 of the illustrated example has a straight portion 314 and a curved portion 316 (e.g., a lip) extending therefrom to form a channel 318 (e.g., a vertically elongate groove or pocket) that is sized to receive the hinge 138 and/or the rear lateral edge 132 (FIGS. 1A, 1B, 2) of the vehicle 104. In particular, the hook 160, which is loosely covered by the fabric cover 162, causes the fabric cover 162 to wrap around the hinge 138 and/or the rear lateral edge 132 of the vehicle 104 to bridge the hinge gaps 142. As described below, because the fabric cover 162 is wrapped around the hook 160 and the stays 158 (e.g., the hook 160 and the stays 158 are contained within a cavity or space defined by an inner surface of the fabric cover 162), the hook 160 and/or the stays 158 can move, slide or otherwise deflect relative to the fabric cover 162 along at least a portion of movement of the hybrid seal 102 as the hybrid seal 120 moves between the non-deflected position or inactive position 128 of FIGS. 1A-1D and the deflected position 200 of FIG. 2. Thus, the hook 160 and stays 158 can move relative to or separately from the fabric cover 162 along at least a portion of movement or deflection of the hybrid seal 102 as the hybrid seal 102 moves between the deflected and non-deflected positions.

The frame 300 of the illustrated example facilitates or enables mounting of the hybrid seal 102 to the dock face 106, the stays 158 of the illustrated example retain and movably couple the example hook 160 relative to the frame 300, and the example fabric cover 162 (e.g., curtains, shells, sealing wraps, fabric panels or sheets, etc.) covers or encases the stays 158, the frame 300, and the hook 160. By wrapping the frame 300, the stays 158, and the hook 160 with the fabric cover 162, costs associated with sewing a side curtain and a separate frame cover are reduced or eliminated. As a result, the example hybrid seal 102 may be significantly less expensive relative to a shelter. Further, the example hybrid seal 102 may be associated with less time in an assembly process, enabling a higher hybrid seal 102 throughput.

FIG. 4 is a perspective view of the example frame 300 of the example side structures 154, 156 of FIGS. 1A, 2, and 3 shown without the fabric cover 162. In particular, FIG. 4 illustrates the frame 300, the hook 160, and the stays 158 of each of the side structures 154, 156. As illustrated in FIG. 4, the stays 158 are spaced apart (e.g., vertically) along a height of the frame 300. The stays 158 of the illustrated example are coupled between the hook 160 and the frame 300 (e.g., the core 308). In particular, example first ends 402 of the stays 158 of the illustrated example are coupled to the hook 160 at an example inner region 404 of the straight portion 314 of the hook 160. In the illustrated example, the stays 158 are coupled to the hook 160 via a fastener. For example, the stays 158 may be coupled to the hook 160 via a fastener including, but not limited to, rivets, self-tapping screws, hook-and-loop fasteners, Keder strips, sewing, an adhesive, ultrasonic welding, and/or any other suitable fastener(s). Additionally, example second ends 406 of the stays 158 of the illustrated example are coupled to the front panel 310. For example, the stays 158 of FIG. 4 are coupled to a front (e.g., a first, a forward) surface 408 of the front panel 310 (e.g., via fasteners such as screws, etc.). In additional or alternative examples, the stays 158 can be coupled to the cover 312, between the front panel 310 and the core 308, between the cover 312 and the front panel 310, etc. The second ends 406 of the stays can be coupled to the front panel 310, the cover 312, and/or the core 308 via fasteners, screws, adhesive, welding, plastic welding, and/or any other fastener(s) or fastening technique.

An example front (e.g., a first, a forward) surface 410 of the core 308 is coupled to the front panel 310 at a rear surface of the front panel 310 (e.g., opposite the front surface 408) via a fastener (e.g., an adhesive). Similarly, an example rear (e.g., second) surface of the core 308 that is opposite the front surface 410 is coupled to an example front (e.g., a forward) surface 412 of the backer 306 via a fastener (e.g., an adhesive). The backer 306 and the front panel 310 of the illustrated example are attached to respective opposite sides of the core 308 via an adhesive (e.g., glue).

The example cover 312 of the illustrated example is coupled (e.g., anchored) to the backer 306 and wrapped around the core 308 and the front panel 310. The cover 312 may be coupled to the backer 306 in different manners such that the cover 312 encases the core 308. For example, a first end 414 of the cover 312 of FIG. 4 is coupled to the front surface 412 of the backer 306 and a second end of the cover 312 opposite the first end is coupled to an example lateral edge 416 and/or the rear surface 306A (FIG. 3) of the backer 306 such that a main region of cover 312 wraps around the core 308 and the front panel 310. In some examples, the first and second ends of the cover 312 overlap to define a separable joint that is to be positioned between the rear surface 306A of the backer 306 and the dock face 106. The cover 312 is coupled to the backer 306 via fasteners 418 rivets, screws, hook-and-loop fasteners, sewing, an adhesive, ultrasonic welding, etc.

The cover 312 of the illustrated example provides support and rigidity to the frame 300. In some examples, the cover 312 protects core 308 from contaminates or elements (e.g., dirt, water, and other elements). The cover 312 of the illustrated example can be one or more sheets of HMWPE and/or another abrasion resistant and/or low-friction material. While the cover 312 of FIG. 4 illustrates a series of sheets 312A along a length of the frame 300, the cover 312 may be a continuous sheet in additional or alternative examples.

While examples disclosed herein are depicted with a series of stays 158, in other examples, the hybrid seal 102 can include a single stay 158. In some such examples, the single stay 158 can extend substantially along a height of the side frame between an uppermost end and a lowermost end of the side frame (e.g., along substantially an entire vertical length of the side frame). In some examples, the stays 158 can be positioned at an angle (e.g., relative to horizontal angle) relative to the hook 160 and/or the respective side structures 154, 156. For example, the stays 158 of the illustrated example have a longitudinal axis that is parallel to horizontal. However in some examples, the stays 158 of the illustrated example can be positioned at a non-parallel angle relative to horizontal (e.g., between approximately 10 degrees and 45 degrees relative to horizontal). In the illustrated example, the hook 160 is a single, continuous hook. In some examples, a length of the hook 160 corresponds to a length of the frame 300 and/or the core 308. In some examples, the hook 160 can include a series of interconnected hooks 160. In some examples, the hook 160 can be a plurality of hooks spaced along a height of the side structures 154, 156. In some examples, the hook 160 can vary in length to adjust a height of the hook when the hybrid seal 102 moves between the inactivated position 128 and the activated position 200.

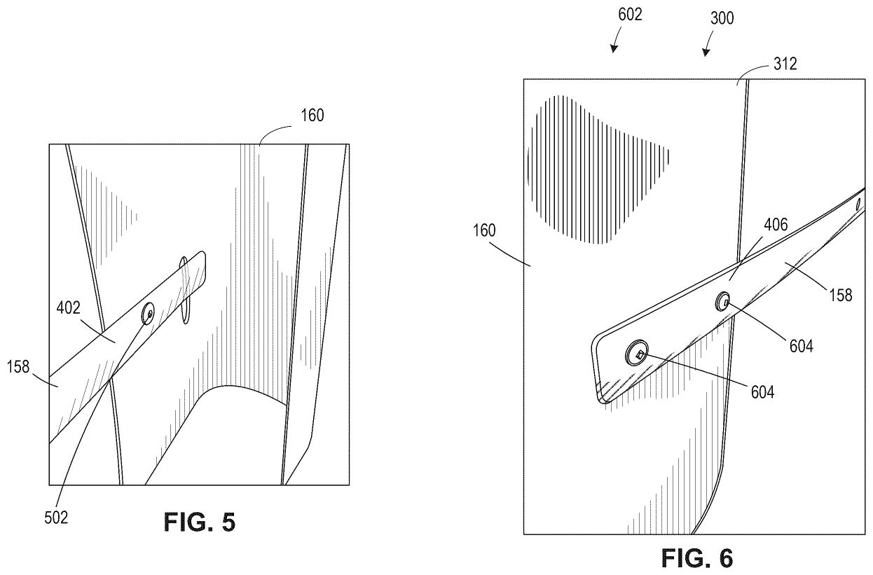

FIG. 5 is an enlarged view of a portion of the hook 160 of FIG. 4. As illustrated in FIG. 5, the stay 158 is coupled to the hook 160 via an example rivet 502. However, the stay 158 can be coupled to the hook 160 using screws, hook-and-loop fasteners, sewing, an adhesive, ultrasonic welding, and/or any other suitable fastener(s). Although only one of the stays 158 is shown, the other stays 158 are similar or identical to the stay 158 shown in FIG. 5.

FIG. 6 is an enlarged view of a portion of the frame 300 of FIGS. 3-4. As illustrated in FIG. 6, the stay 158 is coupled to a front surface 602 of the frame 300. In particular, the stays 158 are anchored to the front surface 602 of the frame 300. The frame 300 of the illustrated example includes the cover 312 wrapped around the front surface 408 (FIG. 4) of the front panel 310 (FIGS. 3-4). Behind the front panel 310 resides the core 308 (FIGS. 3-4). The front panel 310 of the illustrated example defines the front surface 602 of the frame 300 to enable attachment of the stays 158 and the frame 300. In the illustrated example of FIG. 6, the stay 158 is coupled to the front panel 310 via example screws 604. However, the stays 158 can be coupled to the frame 300 and/or the front panel 310 using rivets, screws, hook-and-loop fasteners, sewing, an adhesive, ultrasonic welding, and/or any other suitable fastener(s).

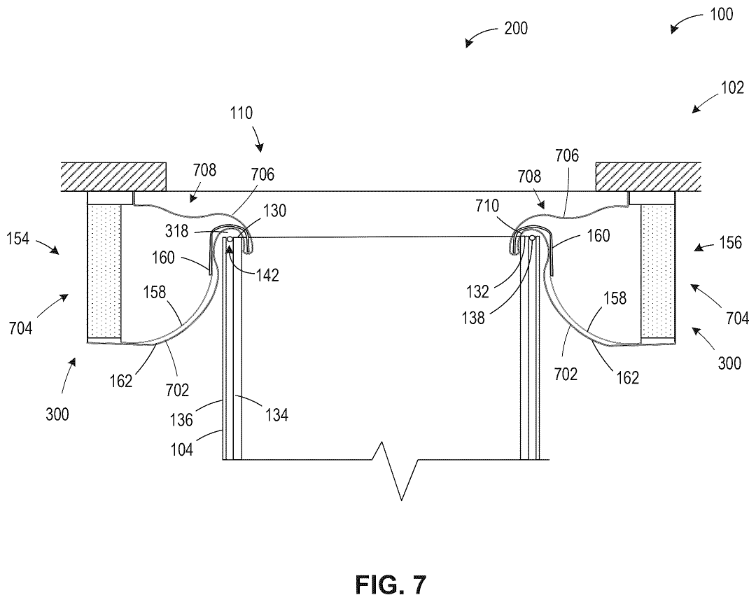

FIG. 7 is a cross-sectional top view of the example hybrid seal 102 of the loading dock 100 shown in the example activated position 200 of FIG. 2. In the activated position 200, the vehicle 104 of the illustrated example is engaged (e.g., in a parked position) with the hybrid seal 102. As the vehicle 104 backs into the hybrid seal 102, the hinges 138 impact the fabric covers 162 and/or the stays 158 positioned behind the fabric covers 162 of the respective first and second side structures 154, 156. Prior to impact of the vehicle 104, the fabric covers 162 are relatively loose. The relative flexibility of the fabric cover 162 enables it to conform to the vehicle 104 while being impacted or engaged by the vehicle 104.

As the vehicle 104 engages the fabric covers 162 of the respective side structures 154, 156, an example first portion 702 of the fabric cover 162 extending between an outer region 704 of a respective side structure 154, 156 and the respective hinges 138 engaging the first portion 702 fabric cover 162 is taut, while an example second portion 706 of the fabric cover 162 extending between the respective hinge 138 and an inner region 708 of the of the respective side structure 154, 156 is loose. In other words, as vehicle 104 continues to move in the rearward direction 148 (FIG. 1A), the rear lateral edges 132 cause the stays 158 of the respective side structures 154, 156 to bend (e.g., fold, etc.), a tension in the fabric covers 162 reduces or loosens. The flexing or bending movement of the stays 158 causes the stays 158 and the hook 160 to move, deflect or swing inwardly towards the respective frames 300 until the hooks 160 cup or engage the respective rear lateral edges 132 of the vehicle 104. Additionally, because the fabric covers 162 wrap the hooks 160 and the stays 158, the hooks 160 and the stays 158 can move or slide relative to (e.g., independently or separately from) their respective fabric covers 162 along at least a portion of a deflection path of the hybrid seal 102 when the vehicle engages the hybrid seal 102. Additionally, because the fabric cover 162 can move separately from the hooks 160 and the stays, the hook 160 receives a portion 710 of the fabric cover 162 (e.g., that can include at least the first and second portions 702, 706) when the hook 160 engages the rear lateral edge 132 of the vehicle,. In particular, the portion 710 is forced into the channel 318 of the hook 160 by a respective one of the rear lateral edges 132 of the vehicle 104. As the vehicle 104 comes to a rest in the parked position (FIG. 2), the fabric covers 162 of the side structures 154, 156 provide a bridge to seal respective ones of the hinge gaps 142. Thus, the hybrid seal 102 bridges gaps between the rear end 130 of the vehicle 104 and the perimeter of the doorway 110 as well as the hinge gaps 142 between the door panels 136 and the rear side panels 134.

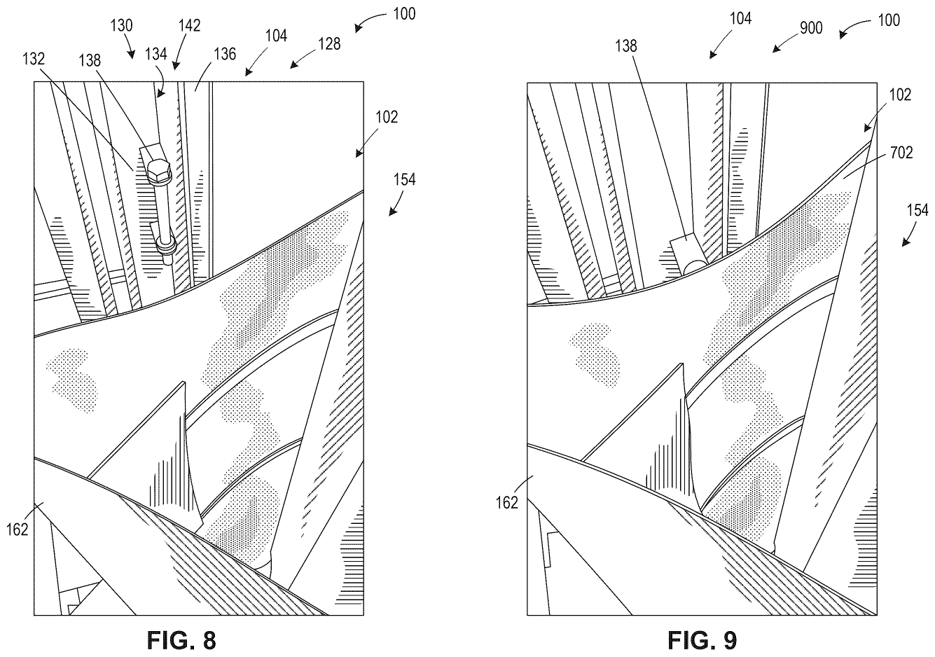

FIGS. 8-13 illustrate the example hybrid seal 102 of the loading dock 100 at various positions 800-1300 between the inactive position 128 (e.g., of FIGS. 1A and 3) and the activated position 200 (e.g., of FIGS. 2 and 7). The hybrid seal 102 of FIGS. 8-13 is shown with an opening at an upper end of the seal for the sole purpose of exposing the components of the hybrid seal 102 to facilitate discussion of operation of FIGS. 8-13. It is to be understood that the hybrid seal 102 is completely enclosed and the components within the fabric covers 162 are not visible or exposed. Although the fabric covers 162 completely enclose the components, the fabric cover 162 can move or slide relative to the hook 160 and/or the stays 158 along at least a deflection path of the hybrid seal 102 (i.e., between a fully deflected position (e.g., the deflected position 200) and a non-deflected position (e.g., the inactive position 128)). In FIGS. 8-13, a first one of the rear lateral edges 132 of the vehicle 104 is illustrated interacting with the side structure 154. Although not shown or described, the side structure 156 operates substantially similar or identical as the side structure 154 when the second one of the rear lateral edges 132 of the vehicle 104 backs into the side structure 156.

FIG. 8 illustrates the vehicle 104 the hybrid seal 102 in the example inactive position 128. The example rear end 130 of the vehicle 104 is oriented towards the example side structure 154 of the hybrid seal 102. The door panel 136 of the vehicle 104 is in the open position 144 and forms the hinge gap 142 between the door panel 136 and the rear side panel 134. The hinge 138 protrude from the rear lateral edge 132 of the vehicle 104. The example fabric cover 162 of the side structure 154 is in a loose (e.g., relaxed) condition.

FIG. 9 illustrates the hybrid seal 102 in a first activated position 900. In the first activated position 900, the vehicle 104 is in a first engagement position as the vehicle 104 moves towards the example parked position of FIGS. 2 and 7. At the first engagement position, the vehicle 104 engages the hybrid seal 102 and partially deflects the fabric cover 162 of the side structure 154. For example, the hinge 138 of the vehicle 104 impacts or engages the fabric cover 162 of the side structure 154 causing deflection and/or an increase in tension of the first portion 702 the fabric cover 162.

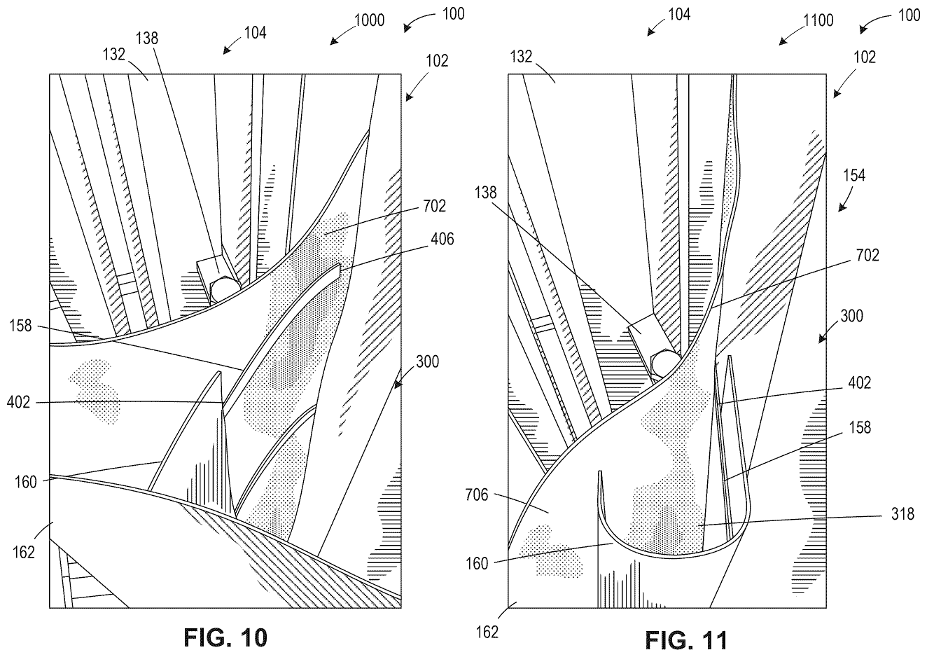

FIG. 10 illustrates the hybrid seal 102 in a second active position 1000. In the second active position 1000, the vehicle 104 is in a second engagement position closer to the parked position of FIGS. 2 and 7. As the vehicle 104 moves to the second engagement position, the rear lateral edge 132 and the hinge 138 of the vehicle 104 slides along fabric cover 162 and impacts the example stays 158. As a result, the stays 158 of the side structure 154 of the illustrated example are deflected or forced to move rearward 138 (FIG. 1A) towards the frame 300 and/or the dock face 106 (FIGS. 1A, 2-3, 7), which causes a reduction in the tension on the second portion 706 of the fabric cover 162. In other words, the hinge 138 and the rear lateral edge 132 of the vehicle 104 cause the first ends 402 of the stays 158 and the hook 160 attached thereto to pivot, deflect, flex, bend, turn or otherwise rotate about the second ends 406 of the stay 158 that are coupled to the front surface 602 (FIG. 6) of the frame 300. Thus, the stays 158 can bend toward the doorway 110 (FIG. 1A, 2-4, 7) of the loading dock 100 when impacted by the vehicle 104.

FIG. 11 illustrates the hybrid seal 102 in a third active position 1100. In the third active position 1100, the vehicle 104 in yet another position closer to the parked position of FIGS. 2 and 7. The rear lateral edge 132 and the hinge 138 of the vehicle 104 slid further along fabric cover 162 and the stays 158 until the rear lateral edge 132 and/or the hinge 138 align or engage the hook 160. Because the fabric cover 162 can slide relative to the hook 160 and the stays 158, the fabric cover 162 can accumulate, fold, or otherwise be received within the hook 160 (e.g., the cavity 318 of the hook 160). The first portion 702 of the fabric cover 162 extending between the outer region 704 (FIG. 7) of the side structure 154 and the hinge 138 increases in tension (e.g., becomes taut) while the second portion 706 of the fabric cover 162 extending between the hinge 138 and the inner region 708 (FIG. 7) of the of the side structure 154 decreases in tension (e.g., becomes loose, slack, or relaxed). Thus, the fabric cover 162 is able to conform to a shape that corresponds to the hook 160.

As illustrated in FIG. 11, the hinge 138 and the rear lateral edge 132 of the vehicle 104 continue to cause the first ends 402 of the stays 158 and the hook 160 to pivot relative to the frame 300 about the second ends 406 (FIGS. 4, 10) of the stays 158. This movement causes the first ends 402 of stays 158 and the hook 160 to move closer to the frame 300 and the dock face 106. Further, the hinge 138 moves toward the channel 318 (e.g., the groove) of the hook 160. Again, such movement of the hook 160 and stays 158 relative to the fabric cover 162 can be achieved by enabling the hook 160 and the stays 158 to move, flex, bend, or otherwise deflect relative to the fabric cover 162. Thus, although the fabric cover 162 wraps around the hook 160 and the stays 158, the hook 160 and/or the stays 158 can slide, bend, or deflect relative to the fabric cover 162.

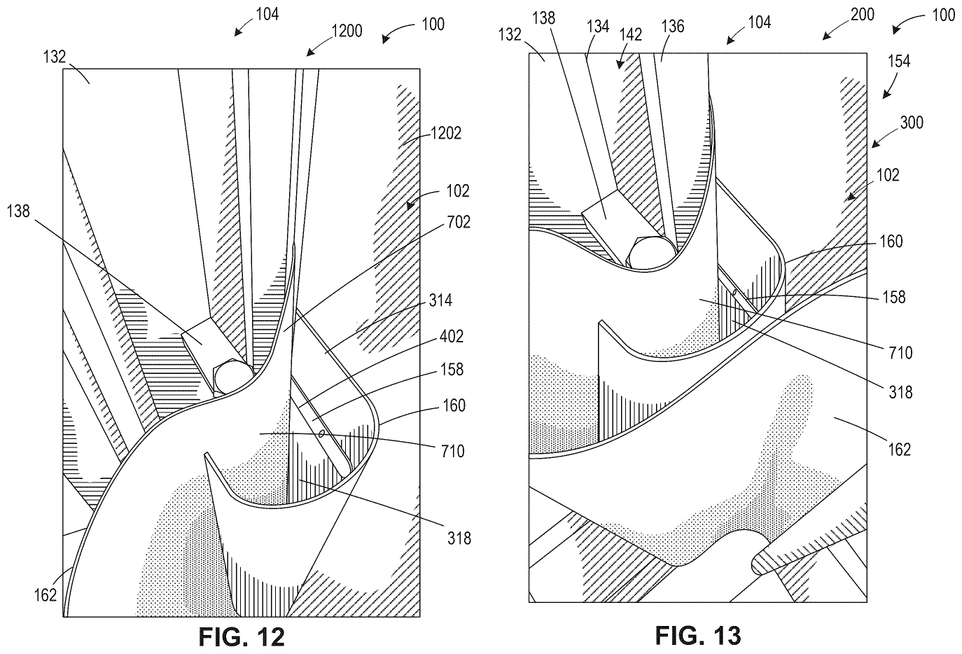

FIG. 12 illustrates the hybrid seal 102 in a fourth active position 1200. In the fourth active position 1200, the vehicle 104 in yet another position closer to the parked position of FIGS. 2 and 7. The hinge 138 and the rear lateral edge 132 of the vehicle 104 cause the first ends 402 of the stays 158 and the hook 160 to pivot about the second ends 406 (FIGS. 4, 10) of the stays 158 such that the straight portion 314 of the hook 160 is substantially parallel relative to a side surface 1202 the frame 300. The hinge 138 positions within and/or engages the channel 318 of the hook 160. To this end, the hinge 138 forces the portion 710 of the fabric cover 162 to enter the channel 318 of the hook 160.

FIG. 13 illustrates the hybrid seal 102 in the activated position (e.g., the fully activated position). For example, the hybrid seal 102 is in the activated position 200 shown in FIG. 2 and FIG. 7. In the activated position 200, the vehicle 104 in the parked position of FIG. 2. The side structure 154 is in the activated position 200. The hinge 138 of the vehicle 104 is positioned at least partially in the channel 318 of the hook 160. In turn, the hinge 138 causes the portion 710 of the fabric cover 162 to be positioned at least partially in the channel 318. As a result, the fabric cover 162 of the side structure 154 wraps around the hinge 138, a portion of the door panel 136, the hinge gap 142, and a portion of the rear side panel 134 (FIGS. 2 and 7). Thus, the side structure 154 bridges the hinge gap 142 as well as gaps that form between the doorway 110 (FIG. 1A) and the vehicle 104 (e.g., the rear lateral edge 132 of the vehicle 104). When the vehicle 104 releases or pulls away from the impacted side structure 154, the impactable side structure 154 returns to its original condition without any permanent deformation to the hook 160, the stays 158, the frame 300 (e.g., the backer 306, the core 308, and/or the front panel 310), and more generally, the impactable side structure 154 and/or the shapes and/or geometries formed thereby.

FIGS. 14A and 14B illustrate the example bumpers 170 that may be added to the loading dock 100 of FIGS. 1A, 2-3, and 7-13. FIG. 14A is a cross-sectional side view of the example hybrid seal 102 of FIGS. 1A and 2-13 with the example bumper 170. FIG. 14B is a front view of the example bumper 170 and the example hybrid seal 102 of FIG. 14A. The bumpers 170 are coupled to an example region 1400 of the dock face 106 to protect or otherwise prevent damage to the loading dock 100. In particular, the bumpers 170 couple to the region 1400 of the dock face 106 that is a structurally strong portion of the loading dock 100. For example, the region 1400 may be formed of concrete while another region of the dock face 106 may be formed of wood, paneling, etc.

The bumpers 170 extend a distance 1404 away (e.g., in a rearward direction 148) from the region 1400 of the dock face 106 to prevent the vehicle 104 (FIGS. 1A-1D) from damaging another component of the loading dock 100. That is, the vehicle 104 is to impact the bumpers 170 when backing towards the loading dock 100 such that the vehicle 104 impacts only impactable components of the loading dock 100. The bumpers 170 are impactable or compressible and are structured to withstand and absorb the impact of the vehicle 104 to prevent damage to the loading dock 100. The bumpers 170 are configured to prevent damage to the loading dock 100 from an impact of the vehicle 104. The bumpers 170 are positioned vertically adjacent the frame 300 such that the bumpers 170 are closer to a driveway 126 (FIGS. 1A, 2, 3) than the side structure 154, 156.

In some examples, the core 308 includes the length 308b of approximately 16 inches and the width 308a of approximately 4 inches. However, the dimensions can differ depending on, for example, materials used to form the hybrid seal 102. For example, dimensions of the core 308 may be selected to increase or optimize rigidity and/or flexibility. In some examples, the dimensions are critical or dependent on one another. For example, the dimensions of components of hybrid seal 102 may be dependent on a type of foam and/or attributes thereof (e.g., stiffness, etc.).

The example hybrid seal 102 can service different sizes and/or configurations of vehicles 104. In some examples, the hybrid seal 102 can services vehicles having trailers that are over 8 feet wide, with up to 6 inches off center in either direction. However, the ability of the hybrid seal 102 to service a given vehicle 104 depends on dimensions of the given hybrid seal 102.

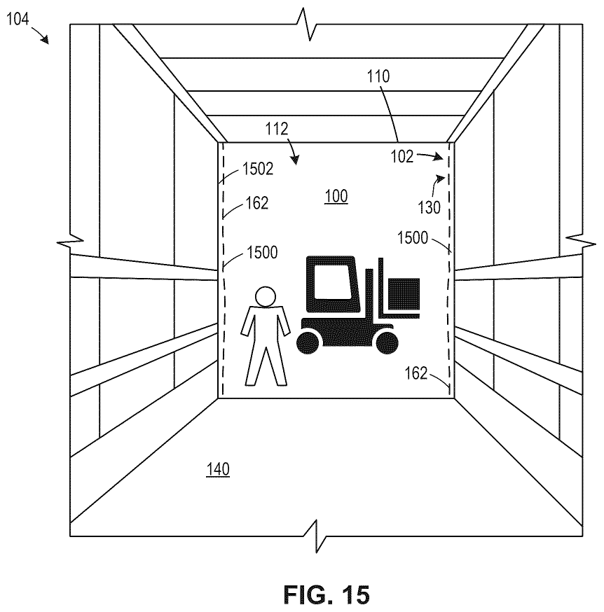

FIG. 15 is partial perspective view of the example loading dock 100 of FIGS. 1A, 2-7, and 14A-14B from a viewpoint inside the vehicle 104 parked at the loading dock 100 looking into the loading dock bay 112 of the loading dock 100. In other words, FIG. 15 is a view of the loading dock bay 112 from the cargo bay 140 of the vehicle 104. The door panels 136 of the vehicle 104 are in the opened position 144 (FIG. 1E), the rear end 130 of the vehicle 104 is aligned with the doorway 110 of the loading dock 100, and the hybrid seal 102 is in the activated position 200 of FIGS. 2 and 7. A passageway is provided between the loading dock bay 112 and the cargo bay 140 of the vehicle 104.

As illustrated by phantom lines in FIG. 15, excess portions 1500 of the fabric covers 162 can protrude into an opening or doorway 1502 of the vehicle 104, in some instances. The seal of the hybrid seal 102 is at least partially provided by the fabric covers 162 (e.g., which is formed of a flexible sealing material). Such flexibility characteristics of the fabric covers 162 can cause the fabric covers 162 to move, fold or collapse when impacted. Thus, vehicles (e.g., forklifts) entering and/or exiting the cargo bay 140 of the vehicle 104 do not damage the hybrid seal 102 upon impact.

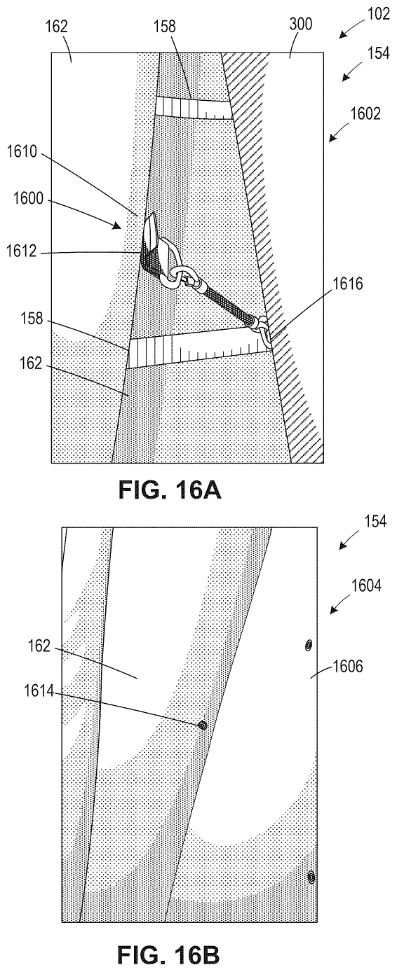

FIGS. 16A-16B are partial views of the example hybrid seal 102 of FIGS. 1A-1D, 2-13, and 14A-14B including an example tether 1600. In particular, FIG. 16A is an inner (e.g., or inside) view 1602 of the side structure 154, illustrating the side structure 154 within the fabric cover 162 (e.g., from a perspective of an inner side of the fabric cover 162). FIG. 16B is an outer view 1604 of the side structure 154, illustrating an outer (e.g., outside) portion 1606 of the fabric cover 162 of the side structure 154.

The tether 1600 of the illustrated example is structured to prevent or reduce the fabric cover 162 from protruding into the opening 1502 (FIG. 15) of the vehicle 104. In particular, the tether 1600 of the illustrated example is to apply a force on an inner portion 1610 of the fabric cover 162 to cause the excess portions 1500 (FIG. 15) of the fabric cover 162 to pull towards the frame 300 of the side structure 154 to prevent the fabric cover 162 from protruding into the opening 144 and/or the opening 1502 (FIG. 15) of the vehicle 104.

To impart a force to excess portions 1500 of the fabric cover 162, the tether 1600 of the illustrated example couples a portion of the fabric cover 162 and the frame 300. For example, the tether 1600 of the illustrated example is a strap that attaches or anchors to the fabric cover 162 and to the frame 300 (e.g., the core 308 of FIG. 3). A first end 1612 of the tether 1600 of the illustrated example is coupled to the inner portion 1610 of the fabric cover 162. For example, FIG. 16B, illustrates the first end 1612 of the tether 1600 coupled to the outer portion 1606 via an example fastener 1614 (e.g., a screw, a rivet, etc.). A second end 1616 of the tether 1600 of the illustrated example opposite the first end 1612 is coupled to the frame 300 and/or the core 308 via an example fastener (e.g., a bracket, a hook, thread (e.g., sewn), a screw, a rivet, etc.). The fastener of this example is a bracket that is attached to the frame 300. In turn the frame 300 is mounted or attached to the dock face 106 (FIGS. 1A-1D), which causes the second end 1614 of the tether 1600 to remain stationary. The relative flexibility of the fabric cover 162 enables the first end 1612 of the tether 1600 to move relative to the second end 1612. For example, the first end 1612 of the tether 1600 can pivot or rotate relative to the second end 1612 and/or the fastener coupled thereto when the hybrid seal 102 moves between the activated position 200 (FIG. 2) and the inactivated position of FIG. 1A to enable the excess portion 1500 of the fabric cover 162 to collapse or move toward the second end 1612 of the tether 1600.

The tether 1600 of the illustrated example can be rope, a bungee cord, and/or another material having tensile strength (e.g., a material that can withstand being stretched or pulled). In other words, the tether 1600 of the illustrated example can be formed of a material that can be stretched or pulled by the fabric cover 162 while the fabric cover 162 is engaged and can return to a resting or initial position when the vehicle 104 disengages the fabric cover 162 as the vehicle 104 departs from the loading dock 100 (e.g., without damage or change in length). In some instances, the tether 1600 includes an elastic or spring-like structure or characteristic that enables the tether 1600 to deflect, collapse, or extend to allow the excess portion 1500 to move relative to the frame 300.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein, the term “substantially perpendicular” encompasses the term perpendicular and more broadly encompasses a meaning whereby a first component is positioned and/or oriented relative to a second component at an absolute angle of no more than five degrees (5°) from perpendicular. For example, a first portion of a first structure (e.g., a frame) that is substantially perpendicular relative to a second structure (e.g., a loading dock floor) is positioned and/or oriented relative to the second structure at an absolute angle of between 85 degrees and 95 degrees. As used herein, the term “substantially parallel” encompasses the term parallel and more broadly encompasses a meaning whereby a first component is positioned and/or oriented relative to a second component at an absolute angle of no more than five degrees (5°) from parallel. For example, a first structure that is substantially parallel relative to a second structure is positioned and/or oriented relative to the second structure at an absolute angle of between 0 degrees and 5 degrees. As used herein, a component that extends “substantially along a height” relative to a second component means that the first component has a first height that is within 10 percent of a second height of the second component. “Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

From the foregoing, it will be appreciated that example methods, apparatus, and articles of manufacture have been disclosed that facilitate control and protection of a loading dock bay environment. The example methods, apparatus, and articles of manufacture provide an example vehicle actuated hybrid seal to seal an example loading dock bay. Example hybrid seals disclosed herein include example provide an efficient seal at a relatively low cost.

At least some of the aforementioned examples include one or more features and/or benefits including, but not limited to, the following:
Example 1 includes an apparatus including a side frame to couple to a loading dock wall; a hook; a stay to couple the hook and the side frame, the stay to enable the hook to move relative to the side frame; and a fabric cover coupled to the side frame, the fabric cover to at least partially cover the hook and the stay, at least one of the hook or the stay to slide relative to the fabric cover.
Example 2 includes the apparatus of example 1, wherein the side frame includes foam reinforced with a high molecular weight polyethylene (HMWPE) material.
Example 3 includes the apparatus of any one of examples 1-2, wherein the foam includes a first side opposite a second side, and a third side opposite a fourth side, the first side to be positioned adjacent the loading dock wall, the third side to be positioned closer to a loading dock door than the fourth side.
Example 4 includes the apparatus of any one of examples 1-3, wherein the side frame includes a board coupled to the second side of the foam.
Example 5 includes the apparatus of any one of examples 1-4, wherein the stay is disposed between the foam and the hook.
Example 6 includes the apparatus of any one of examples 1-5, wherein the side frame is coupled to a first panel, the first panel to be coupled to the loading dock wall.
Example 7 includes the apparatus of any one of examples 1-6, wherein the stay is formed of fiberglass.
Example 8 includes the apparatus of any one of examples 1-7, wherein the stay has a first end coupled to the side frame and a second end opposite the first end coupled to the hook.
Example 9 includes the apparatus of any one of examples 1-8, wherein the first end of the stay is coupled to the side frame via a first fastener and the second end of the stay is coupled to the hook via a second fastener.
Example 10 includes the apparatus of any one of examples 1-9, wherein the first fastener includes screws and the second fastener includes rivets.
Example 11 includes the apparatus of any one of examples 1-10, wherein the fabric cover surrounds the side frame, the stay, and the hook.
Example 12 includes seal having a side frame including a foam core, a hook coupled to the side frame, the hook to flex relative to the foam core, and a fabric cover at least partially wrapped around the foam core and the hook, the hook to move relative to the fabric cover along at least a portion of a deflection path of the seal between a fully deflected position and a non-deflected position of the seal.
Example 13 includes the seal of example 12, wherein the foam is a reinforced with a high molecular weight polyethylene (HMWPE) material.
Example 14 includes the seal of any one of examples 12-13, further including a stay to couple the hook and the side frame, the stay to enable the hook to deflect relative to the side frame.
Example 15 includes the seal of any one of examples 12-14, wherein at least a portion of the fabric is to be received by the hook when the hook is engaged by a vehicle at a loading dock.
Example 16 includes the seal of any one of examples 12-15, further including a tether having a first end coupled to an inner portion of the fabric and a second end opposite the first end coupled to at least one of the foam core or the side frame.
Example 17 includes the seal of any one of examples 12-16, wherein the tether is to apply a force on the inner portion of the fabric cover to cause excess portions of the fabric cover to pull towards the side to prevent the fabric cover from protruding into an opening of a vehicle during a loading/unloading operation.
Example 18 includes a method comprising coupling a foam core to a side frame, the side frame to attach to a wall of a loading dock adjacent a doorway; coupling a hook to at least one of the foam core or the side frame via a flexible stay, the flexible stay to enable the hook to bend relative to the foam core; and wrapping at least portions of the side frame, the foam core, the hook and the stay with a fabric cover, the fabric cover to move relative to the hook and the stay when the hook deflects between a deflected position and a non-deflected position.
Example 19 includes the method of example 18, the method further including further including attaching a tether to at least a portion of the fabric cover and the side frame.
Example 20 includes the method of any one of examples 18 and 19, the method further including further including encasing the side frame, the hook, and the stay with the fabric cover.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus comprising:
a side frame to couple to a loading dock wall;
a hook;
a stay to couple the hook and the side frame, the stay to enable the hook to move relative to the side frame; and
a fabric cover coupled to the side frame, the fabric cover to at least partially cover the hook and the stay, at least one of the hook or the stay to slide relative to the fabric cover.

2. The apparatus of claim 1, wherein the side frame includes foam reinforced with a high molecular weight polyethylene (HMWPE) material.

3. The apparatus of claim 2, wherein the foam includes a first side opposite a second side, and a third side opposite a fourth side, the first side to be positioned adjacent the loading dock wall, the third side to be positioned closer to a loading dock door than the fourth side.

4. The apparatus of claim 3, wherein the side frame includes a board coupled to the second side of the foam.

5. The apparatus of claim 3, wherein the stay is disposed between the foam and the hook.

6. The apparatus of claim 1, wherein the side frame is coupled to a first panel, the first panel to be coupled to the loading dock wall.

7. The apparatus of claim 1, wherein the stay is formed of fiberglass.

8. The apparatus of claim 1, wherein the stay has a first end coupled to the side frame and a second end opposite the first end coupled to the hook.

9. The apparatus of claim 8, wherein the first end of the stay is coupled to the side frame via a first fastener and the second end of the stay is coupled to the hook via a second fastener.

10. The apparatus of claim 9, wherein the first fastener includes screws and the second fastener includes rivets.

11. The apparatus of claim 1, wherein the fabric cover encases the side frame, the stay, and the hook.

12. A seal comprising:
a side frame including a foam core;
a hook coupled to the side frame, the hook to flex relative to the foam core; and
a fabric cover at least partially wrapped around the foam core and the hook, the hook to move relative to the fabric cover along at least a portion of a deflection path of the seal between a fully deflected position and a non-deflected position of the seal.

13. The seal of claim 12, wherein the foam is reinforced with a high molecular weight polyethylene (HMWPE) material.

14. The seal of claim 12, further including a stay to couple the hook and the side frame, the stay to enable the hook to deflect relative to the side frame.

15. The seal of claim 12, wherein at least a portion of the fabric is to be received by the hook when the hook is engaged by a vehicle at a loading dock.

16. The seal of claim 12, further including a tether having a first end coupled to an inner portion of the fabric and a second end opposite the first end coupled to at least one of the foam core or the side frame.

17. The seal of claim 16, wherein the tether is to apply a force on the inner portion of the fabric cover to cause excess portions of the fabric cover to pull towards the side to prevent the fabric cover from protruding into an opening of a vehicle during a loading/unloading operation.

18. A method comprising:
coupling a foam core to a side frame, the side frame to attach to a wall of a loading dock adjacent a doorway;
coupling a hook to at least one of the foam core or the side frame via a flexible stay, the flexible stay to enable the hook to bend relative to the foam core; and
wrapping at least portions of the side frame, the foam core, the hook and the stay with a fabric cover, the fabric cover to move relative to the hook and the stay when the hook deflects between a deflected position and a non-deflected position.

19. The method of claim 18, further including attaching a tether to at least a portion of the fabric cover and the side frame.

20. The method of claim 18, further including encasing the side frame, the hook and the stay with the fabric cover.
